(19) United States
(12) Patent Application Publication
(10) Pub. No.: US 2026/0233611 A1
(43) Pub. Date: Aug. 13, 2026

(54) INDICATOR SYSTEM FOR A DRIVER ASSISTANCE SYSTEM

(71) Applicant: Jaguar Land Rover Limited, Coventry, Warwickshire (GB)

(72) Inventors: Sandra SEDDON, Coventry, West Midlands (GB); Luis HERNANDEZ-MUNOZ, Coventry, West Midlands (GB); Roland BARGE, Loughborough, Leicestershire (GB)

(21) Appl. No.: 19/470,327

(22) PCT Filed: Jan. 12, 2024
(86) PCT No.: PCT/EP2024/050649

§ 371 Date: Sep. 29, 2025

(30) Foreign Application Priority Data
Mar. 31, 2023 (GB) 2304806.9

(51) Int. Cl. B60K 35/65; B60K 35/10; B60K 35/22; B60K 35/81; G06F 3/0482; G06F 3/04847; G06F 3/0485

(52) U.S. Cl. CPC B60K 35/654; B60K 35/10; B60K 35/22; B60K 35/81; G06F 3/0482; G06F 3/04847; G06F 3/0485

(57) ABSTRACT

Aspects of the present invention relate to a control system for controlling a driver assistance system indicator system of a vehicle. The control system is configured to: set a driver assistance system indication mode of the driver assistance system indicator system to a high indication mode at the start of a drive cycle. The control system is configured to output a mode indicator signal to indicate that the driver assistance system indication mode is set to the high indication mode. The control system is configured to receive at least one input signal indicative of a request to change the driver assistance system indication mode from the high indication mode, and change the driver assistance system indication mode from the high indication mode to a different indication mode. The control system is configured to output a mode change signal configured to cause the display screen to change the mode indicator.

### TECHNICAL FIELD

The present disclosure relates to an indicator system for a driver assistance system. Aspects of the invention relate to a control system, a system, a vehicle, a method and computer readable instructions.

### BACKGROUND

It is known to provide driver assistance features to aid a driver driving a vehicle. For example, a driver may be warned that they are exceeding the speed limit. A driver may be alerted to which driver assistance features are activated, for example by a sound alerting the driver to the feature being operational. A driver may be able to enter the driver assistance settings of the system and customise the alerts which are provided in relation to active driver assistance features. In some cases, the customisation settings may be removed once the engine is turned off, so the same alerts are provided at the start of each drive cycle regardless of whether a driver has deactivated any in a previous drive cycle. This re-setting of driver assistance alerts may be performed to meet regulatory requirements. The driver may not be able to easily customise which alerts are provided, in particular once the driver has commenced driving. Examples disclosed herein aim to solve the problem of facilitating driver customisation of driver assistance system alerts.

It is an aim of the present invention to address one or more of the disadvantages associated with the prior art.

### SUMMARY OF THE INVENTION

Aspects and embodiments of the invention provide a control system, a system, a vehicle, a method, and computer readable instructions as claimed in the appended claims.

According to an aspect of the present invention there is provided a control system for controlling a driver assistance system indicator system of a vehicle, the control system comprising one or more controller, the control system configured to: receive an input signal indicative of a driver request to change a driver assistance system indication mode to a new indication mode from a current indication mode; in dependence on the input signal: output a driver assistance system indication mode signal to set a driver assistance system indication mode of the driver assistance system indicator system to a new indication mode from a high indication mode, wherein different driver assistance system indicators are provided in the new indication mode compared with the current indication mode; and output a driver assistance system indication mode indicator signal to set a driver assistance system indication mode indicator to indicate operation of the new indication mode. Advantageously, a driver can change a level of driver assistance system indication regarding the driver assistance being provided by the vehicle (for example, if there are currently too many indicators, which cause annoyance, signalling operation of various driver assistance systems) and an indication of the level of indication is provided (such as an illuminated icon) so the driver can readily understand which driver assistance mode indication mode the vehicle is operating in.

According to an aspect of the present invention there is provided a control system for controlling a driver assistance system indicator system of a vehicle, the control system comprising one or more controller, the control system configured to: set a driver assistance system indication mode of the driver assistance system indicator system to a high indication mode at the start of a drive cycle, wherein the driver assistance system indicator system is configured to indicate operation of the driver assistance system of the vehicle, and wherein the high indication mode is a mode in which a plurality of operation indicators corresponding to respective operational driver assistance functions of the driver assistance system are turned on; output a mode indicator signal, the mode indicator signal configured to cause a display screen to display, in the field of view of a driver of the vehicle looking at the road ahead, a mode indicator to indicate that the driver assistance system indication mode is set to the high indication mode; receive at least one input signal, the at least one input signal indicative of a user input made to an input element located at the steering wheel of the vehicle, the at least one input signal indicative of a request to change the driver assistance system indication mode from the high indication mode; in dependence on the at least one input signal, change the driver assistance system indication mode from the high indication mode to a different indication mode by disabling one or more of the plurality of operation indicators in accordance with the different indication mode; and output a mode change signal, the mode change signal configured to cause the display screen to change the mode indicator to indicate that the driver assistance system indication mode is set to the different indication mode.

At the start of a drive cycle, a particular plurality of driver assistance system indicators may be provided to inform the driver that the corresponding driver assistance system functionality is active, for example according to General Safety Regulation 2 (GSR2) requirements. It is permissible to stop at least some of these driver assistance system indicators from being provided while driving, although they will be provided as a default at the start of the drive cycle according to GSR2 requirements. Advantageously, the driver is provided with convenient control of which driver assistance system indicators are provided during driving by way of the input element which is located at the steering wheel of the vehicle, and so the driver does not need to move their hands away from the steering wheel to select a preferred indication mode. The driver is not required to enter a settings menu and manually change one or more of the driver assistance system indicator settings. Furthermore, the driver is advantageously provided with a visual indicator in their field of view, without the driver's attention being taken away from the road ahead, to show which driver assistance system indicators are being provided. This indicator comprises the mode indicator which shows the current driver assistance system indication mode. The driver is not required to shift their visual attention away from the road ahead in order to see via the user interface and determine the current driver assistance system indication mode in operation.

The “field of view” of the driver looking at the road ahead may be considered to extend over a region in front of the driver looking forwards through the windscreen. That is, as the driver's eye direction is towards the front of the vehicle at the road ahead, the mode indicator is also visible to the driver without the driver needing to direct their visual attention away from the road ahead to see the mode indicator (for example, the driver does need to move their head to look away from the road ahead). The driver can observe both the road ahead and the mode indicator without moving their visual attention away from the road ahead, at least for any longer than a short period e.g. 1 second or 0.5 seconds. The mode indicator may be displayed in the dashboard cluster acting as a display screen, alongside other driving parameter indicators such as the speedometer or rev counter, for example.

The one or more controllers may collectively comprise: at least one electronic processor having an electrical input for receive at least one input signal; having an electrical output for providing at least one output signal, and having at least one memory device electrically coupled to the at least one electronic processor and having instructions stored therein; and wherein the at least one electronic processor is arranged to access the at least one memory device and execute the instructions thereon so as to:
set a driver assistance system indication mode of the driver assistance system indicator system to a high indication mode at the start of a drive cycle, wherein the driver assistance system indicator system is configured to indicate operation of the driver assistance system of the vehicle, and wherein the high indication mode is a mode in which a plurality of operation indicators corresponding to respective operational driver assistance functions of the driver assistance system are turned on;
output a first output signal comprising a mode indicator signal, the mode indicator signal configured to cause a display screen to display, in the field of view of a driver of the vehicle looking at the road ahead, a mode indicator to indicate that the driver assistance system indication mode is set to the high indication mode; receive at least one input signal, the at least one input signal indicative of a user input made to an input element located at the steering wheel of the vehicle, the at least one input signal indicative of a request to change the driver assistance system indication mode from the high indication mode;
in dependence on the at least one input signal, change the driver assistance system indication mode from the high indication mode to a different indication mode by disabling one or more of the plurality of operation indicators in accordance with the different indication mode; and
output a second output signal comprising a mode change signal, the mode change signal configured to cause the display screen to change the mode indicator to indicate that the driver assistance system indication mode is set to the different indication mode.

The input element located at the steering wheel of the vehicle may be an input element which is located on the central portion of a steering wheel, on an outer portion of the steering wheel, on a steering column of the steering wheel, or within a particular distance from the steering wheel (e.g. within 10 cm) which can be readily reached by a driver operating the steering wheel.

The plurality of operation indicators may comprise indicators corresponding to one or more of:
an indication of the current vehicle speed in relation to a speed limit at the location of the vehicle;
an indication off an upcoming change in the speed limit on the road ahead;
an indication warning of a potential forwards collision of the vehicle; and
an indication of lane assistance functionality being active in the vehicle.

The driver assistance system indication mode may comprise a plurality of indication modes stored as a numbered list in a memory of the vehicle. The high indication mode may be the first entry of the list. An indication mode lower on the numbered list may provide a lower level of indication than an indication mode higher on the numbered list. Advantageously, the indication modes can be scrolled through by providing plural input to the input element, for example by using a jog wheel or repeated pressing of a button.

The plurality of indication modes may include the high indication mode, a custom indication mode, and a low indication mode. The custom indication mode may be an indication mode in which a predetermined selection of the plurality of operation indicators are turned on. For example, the driver may have pre-stored a preferred customisation of indications in a custom indication mode. The low indication mode may be an indication mode in which a subset of the plurality of operation indicators are turned on, wherein the subset of operation indicators represents operation indicators which cannot be turned off. Advantageously, the user is able to quickly switch to a pre-stored indication mode which defines a particular plurality of driver assistance system indicators which are in operation, without for example, being required to enter a settings menu and manually activate or deactivate individual driver assistance system indicators.

The at least one input signal may comprise a mode change input signal indicative of a user request to enter a mode selection mode; followed by one or more mode selection input signals, wherein each of the one or more mode selection input signals is indicative of a request to change the driver assistance system indication mode to a next indication mode in the numbered list. Advantageously, the user is able to provide input to the input means to first indicate that they wish to change the driver assistance system indication mode, followed by further input to scroll through the available indication modes. In this way, the initial input to indicate a desire to change mode helps to ensure that the indication mode is not switched accidentally by accidentally tapping or knocking the input means once, and the second (and further) inputs are those which allow for quick cycling through the available mode to select a desired mode.

The control system may be configured to: determine, in response to receiving each of the one or more mode selection input signals, whether a predetermined period of time has passed since receiving the mode change input signal; wherein, after the predetermined period of time has passed, if a further input signal is received indicative of a further user input made to the input element located at the steering wheel of the vehicle, the further input signal is determined to be a further mode change input signal indicative of a request to enter the mode selection mode. Advantageously, the user is required to provide successive inputs within a predetermined time period, otherwise the control system reverts back to requiring an initial input to indicate a desire to change the current mode before the mode is able to be changed. This further protects against accidental mode switching, for example by knocking or touching the input means by accident.

The indication mode may not be changed until the predetermined period of time has passed following selection of a particular indication mode. Advantageously, this helps prevent a change to the control of all the driver assistance system indicators to be in a particular selected mode until the particular indication mode is decided upon.

The control system may be configured to: in response to receiving a driver assistance system indication mode information page input, output a mode information page display signal to cause the display screen to display a driver assistance system mode information page. The driver assistance system mode information page may comprise information indicative of: the operational driver assistance functions of the driver assistance system; and which driver assistance system indicators are provided in each of the driver assistance system indication modes. The driver assistance system mode information page may be, for example, a driver assistance system mode page displayed on a touch-sensitive display screen, for example a display screen configured to provide other displayed content and functionality such as infotainment content and functionality. Advantageously, an input may be made to access a driver assistance system mode information page to provide information on which driver assistance system indicators are operational, and which are not, in the current (or an available) indication mode.

Each of the at least one input signal indicative of a request to change the driver assistance system indication mode may comprise a short duration user input to the input means; and the driver assistance system indication mode information page input may comprise a long duration user input to the input means. Advantageously, the user need only interact with a single input means to be able to both control which driver assistance system indicated mode is in operation, as well as obtain further information about each driver assistance system indication mode if required by using a long duration user input. The longer (more time consuming/deliberate) input accesses the page showing a higher level of driver assistance system indicator information.

The information regarding the available indication modes may comprise information of each operation indicator and whether each operator indicator is turned on or off for a selected driver assistance system indication mode. Advantageously, it is clear which indicators are operational in a particular indication mode.

The control system may be configured to output a mute signal, the mute signal configured to mute audio output when the mode change input signal is received. Advantageously, a clear audio indication (muting of audio output being provided at the time of selection of mode) may be provided to indicate to the user that the indication mode is changed. On selection of a different indication mode, an initial test audio indication output may be provided in some examples to indicate to the driver which audio indications can be provided during operation in the selected mode, and muting audio output not related to the indications when the different mode is selected can help provide a clearer audio indication.

The plurality of operation indicators may comprise one or more of: a visual indicator, an audio indicator, and a haptic feedback indicator. Advantageously, the various operation indicators may provide visual, audio, and/or haptic information to a user, and the user may be able to switch on or switch off specific indicators and the type of indication provided to provide a preferred plurality of indicators, for example in a predetermined custom indication mode.

The input element may comprise one or more of: a push button, a dial, a switch, a jog wheel, and a touch pad. Advantageously, for example, a push button allows the user to simply push the button a number of times in order to scroll through and select a preferred indication mode; a jog wheel or dial allows the user to simply jog the wheel a number of times in order to scroll through and select a preferred indication mode, and may for example allow a user to move back and forth through the list of available indication modes rather than being able to scroll through in one direction only.

According to an aspect of the present invention there is provided a system for a vehicle, the system comprising any control system disclosed herein, any input element disclosed herein, and a display screen.

Advantageously, a desired plurality of driver assistance system indicators can be selected for provision using the control system, via input provided by a user to the input element, with an indication of the indication mode defining a particular plurality of driver assistance system indicators to be operational displayed on the display screen.

According to an aspect of the present invention there is provided a vehicle comprising any system disclosed herein or any control system disclosed herein.

According to an aspect of the present invention there is provided a method for controlling a driver assistance system indicator system of a vehicle, the method comprising:
setting a driver assistance system indication mode of the driver assistance system indicator system to a high indication mode at the start of a drive cycle, wherein the driver assistance system indicator system is configured to indicate operation of the driver assistance system of the vehicle, and wherein the high indication mode is a mode in which a plurality of operation indicators corresponding to respective operational driver assistance functions of the driver assistance system are turned on;
outputting a mode indicator signal, the mode indicator signal configured to cause a display screen to display, in the field of view of the driver of the vehicle, a mode indicator to indicate that the driver assistance system indication mode is set to the high indication mode;
receiving at least one input signal, the at least one input signal indicative of a user input made to an input element located at the steering wheel of the vehicle, the at least one input signal indicative of a request to change the driver assistance system indication mode from the high indication mode;
in dependence on the at least one input, changing the driver assistance system indication mode from the high indication mode to a different indication mode by turning off one or more operation indicators in accordance with the different mode; and
outputting a mode change signal, the mode change signal configured to cause the display screen to change the mode indicator to indicate that the driver assistance system indication mode is set to the different indication mode.

In an aspect there is provided computer readable instructions which, when executed by a computer, are arranged to perform any method disclosed herein. In an aspect there is provided a non-transitory, computer-readable storage medium storing instructions thereon that, when executed by one or more electronic processors, causes the one or more electronic processors to carry out any method disclosed herein. Advantageously, methods disclosed herein may be performed by computer code operating in an existing vehicle driver assistance system indicator system.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle comprising a control system for controlling a driver assistance system indicator system of a vehicle according to examples disclosed herein;

FIG. 2 shows a controller of a control system for controlling a driver assistance system indicator system of a vehicle according to examples disclosed herein;

FIG. 3 shows a controller of a control system performing an example process of controlling a driver assistance system indicator system of a vehicle according to examples disclosed herein; and

FIG. 4 shows a schematic example process of controlling a driver assistance system indicator system of a vehicle according to examples disclosed herein.

### DETAILED DESCRIPTION

Driver assistance systems (also known as driving assistance systems, or DAS) can provide useful assistive driving features for drivers, to improve operation of a vehicle and assist drivers with driving and parking. Examples of driver assistance include forward collision warnings, lane departure assistance, parking sensors, tyre pressure monitoring, automatic parking, electronic stability control, traffic sign recognition, and many others. There may be an indicator, such as a displayed symbol or audio tone, to indicate to a driver that a particular DAS is active. In certain circumstances, at the start of a drive cycle (i.e. when the vehicle is powered on/the ignition is started), a particular set of driver assistance features may be indicated to the driver to highlight that those driver assistance features are operational. For example, visual and audible feedback for overspeed warnings, visual and audible feedback for new speed limits, and visual, audible and haptic feedback for lane assistance control may be required to be on at each drive cycle in new General Safety Regulation 2 (GSR2) regulations. This feedback, which may be a different type of indication level compared with previous settings, may be new to a driver, and could lead to driver annoyance as being perceived to be too much information being indicated. While regulations may require a certain set of DAS indicators to be operational at the start of the drive cycle, they may not necessarily need to be in operation throughout the drive cycle to meet regulatory requirements.

Examples disclosed here provide so-called “Driver Assistance Modes”, which allow for new functionality to be available to the vehicle occupant, in addition to regulated content (e.g. DAS indications provided to meet regulations). Driver Assistance Modes may allow a vehicle user to quickly navigate to a preferred DAS indication setting mode (allowing customisation of which indication features are turned on or off as desired, following initiation of the drive cycle). Access may be, for example, via a switch on the steering wheel. Feedback as to which Driver Assistance Modes is currently operational may be provided in visual feedback locations, such as the vehicle cluster (e.g. above the steering wheel alongside other indicators such as the speedometer and rev counter) or in another vehicle display screen. Customisation of a particular custom Driver Assistance Mode may be available, for example through interaction with a customisation GUI through a central touch screen. Examples disclosed herein allow for a driver to easily switch to a particular driver assistance mode (that is, a particular set of active DAS indications) with reduced distraction whilst driving, through use of an input means to select a particular DAS indication mode, and a DAS indication mode indicator displayed in the field of view of the driver looking ahead.

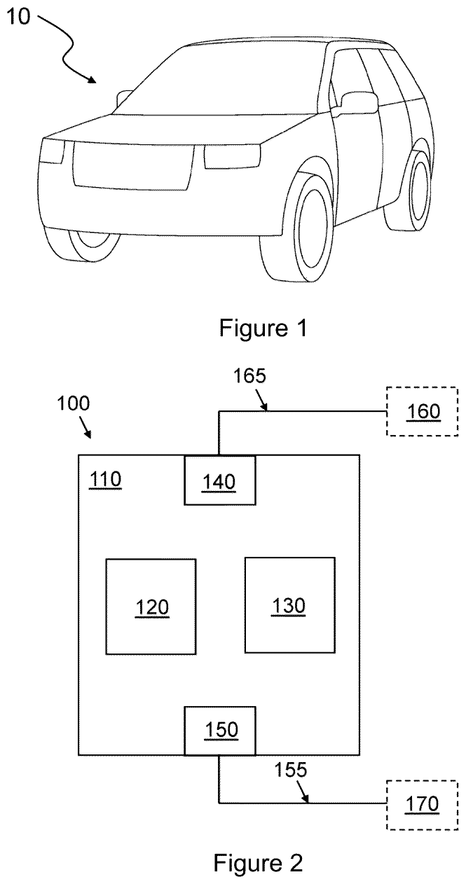

A vehicle in accordance with an embodiment of the present invention is described herein with reference to the accompanying FIG. 1. FIG. 1 illustrates a vehicle 10 comprising a control system 100 for controlling a DAS indicator system of the vehicle, such as the control system 100 of FIG. 2. The vehicle 10 comprises sensor systems which are configured to provide driver assistance as part of the DAS, such as cameras, LIDAR, mapping information, and/or other sensors and systems for providing the DAS (not shown).

A control system 100 in accordance with an embodiment of the present invention is described herein with reference to the accompanying FIG. 2. The control system 100 may be installed in a vehicle 10. FIG. 2 shows a controller 110 of a control system 100 for controlling a DAS indicator system of the vehicle. The control system 100 is configured to control the indicators which indicate the current DAS functionality being provided. The particular indicators which may indicate to the driver and vehicle occupants that that driver assistance functionality is available need not all necessarily be in operation throughout the drive cycle, and the control system 100 may be used to control the indicators being provided.

The control system 100 as illustrated in FIG. 2 comprises one controller 110, although it will be appreciated that this is merely illustrative and in other examples may comprise a plurality of controllers 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon. The controller 110 comprises an input means 140 and an output means 150. The input means 140 may comprise an electrical input 140 of the controller 110 configured to receive input signals 165. The output means 150 may comprise an electrical output 150 of the controller 110 configured to provide output signals 155. An output device 170 may be configured to receive the output signals 155.

A DAS indicator system of a vehicle 10 is configured to indicate operation of the DAS of the vehicle.

For example, the control system 100 is configured to receive an input signal 165 indicative of a driver request to change a DAS indication mode to a new indication mode from a current indication mode. In dependence on the input signal 165 the control system 100 is configured to output a DAS indication mode signal 155 to set a DAS indication mode of the DAS indicator system to a new indication mode from a high indication mode, wherein different DAS indicators are provided in the new indication mode compared with the current indication mode; and output a DAS indication mode indicator signal 155 to set a DAS indication mode indicator to indicate operation of the new indication mode. Advantageously, a driver can change a level of DAS indication regarding the driver assistance being provided by the vehicle (for example, if there are currently too many indicators signalling operation of various DASs) and an indication of the level of indication is provided (such as an illuminated icon) so the driver can readily understand which driver assistance mode indication mode the vehicle is operating in. The input signal may be provided to a button and cause both the indication mode to change as well as the indication mode indicator to update and reflect the selected indication mode in operation.

As another example, the control system 100 is configured to set a DAS indication mode of the DAS indicator system to a high indication mode at the start of a drive cycle, for example by providing an indication mode signal 155 to the DAS indicator system (as an example of an output device 170) indicative of a request to set the indication mode to a high indication mode. The high indication mode is a mode in which a plurality of operation indicators corresponding to respective operational driver assistance functions of the DAS are turned on. Thus the control system 100 is able to control the level/amount of DAS indicators provided to the driver. Examples of DAS indicators include audio indicators to indicate which DASs are operational (e.g. a beep when a reverse gear is selected to indicate that rear parking assistance is active), visual indicators to indicate which DASs are operational (e.g. a light on a dashboard to indicate that lane assistance is active), and/or haptic indicators (e.g. a vibration of the steering wheel to indicate that forward collision sensing is active).

The plurality of operation indicators may comprise indicators corresponding to one or more of: an indication of the current vehicle speed in relation to a speed limit at the location of the vehicle; an indication of an upcoming change in the speed limit on the road ahead; an indication warning of a potential forward collision or emergency braking of the vehicle; and an indication of lane assistance functionality being enabled in the vehicle, and an indication of parking assistance functionality being enabled in the vehicle, for example.

The control system 100 is configured to output a mode indicator signal (i.e. output signal 155), for example via the output means 150. The mode indicator signal 155 is configured to cause a display screen (as an example output device 170) to display, in the field of view of a driver of the vehicle looking at the road ahead, a mode indicator to indicate that the DAS indication mode is set to the high indication mode. The “field of view” may be defined as being located in front of the driver looking at the road ahead when driving during forward movement of the vehicle, i.e. when the driver is looking through the windscreen directly in front of the driver. The mode indicator is located so that the driver is able to see the indicator without having to take their visual attention away from the road ahead, in a similar way that a driver can check the vehicle speed by looking at the speedometer which is located in the field of view of the driver looking at the road ahead. The driver need not take their visual attention away from the road ahead, or significantly move their head or body in order to be able to see the indicator. The mode indicator may be displayed in the dashboard cluster as an example of the display screen. The mode indicator may be displayed in a heads-up display as an example of the display screen.

Thus the control system 100 is also able to control a DAS indication mode indicator, which indicates to the driver what level of DAS indication is being provided to the driver. An example DAS indication mode indicator is a visual indicator schematically showing portions of a vehicle which may be illuminated differently to indicate the level of DAS indication currently being provided. For example, if indications that lane assistance are active, side/door portions of the schematic vehicle shaped indicator may be illuminated; if indications that forward parking sensors are disabled, a forward facing portion of the schematic vehicle shaped indicator may not be illuminated.

The control system 100 is configured to receive at least one input signal 165. The at least one input signal 165 is indicative of a user input made to an input element (as an example input device 160) located at the steering wheel of the vehicle. The at least one input signal 165 is indicative of a request to change the DAS indication mode from the high indication mode. Thus, the user can make an input to indicate that they wish to change the level of driver assistance mode indication being provided. The control system 100 is configured to, in dependence on the at least one input signal 165, change the DAS indication mode from the high indication mode to a different indication mode by disabling one or more of the plurality of operation indicators in accordance with the different indication mode.

The input element being located at the steering wheel of the vehicle may be considered to be located where it can be readily reached by a driver operating the steering wheel without requiring the driver to let go of the steering wheel, or let go for any prolonged length of time, e.g. it may be used and the driver's hand return to the steering wheel within 1 second. For example it may be located on the central portion of a steering wheel, on an outer portion of the steering wheel, on a steering column of the steering wheel, or within a particular distance from the steering wheel (e.g. within 10 cm) which can be readily reached by a driver operating the steering wheel. In examples, the input element may be a physical switch, giving the driver operation the vehicle the ability to locate the position of the input element by touch, as opposed to a touch screen input that would require location by sight.

The control system 100 is configured to output a mode change signal (i.e. output signal 155). The mode change signal 155 is configured to cause the display screen 170 to change the mode indicator to indicate that the DAS indication mode is set to the different indication mode. For example, if indications that lane assistance is active are no longer provided in the different indication mode, previously illuminated side/door portions of the schematic vehicle shaped indicator may be extinguished.

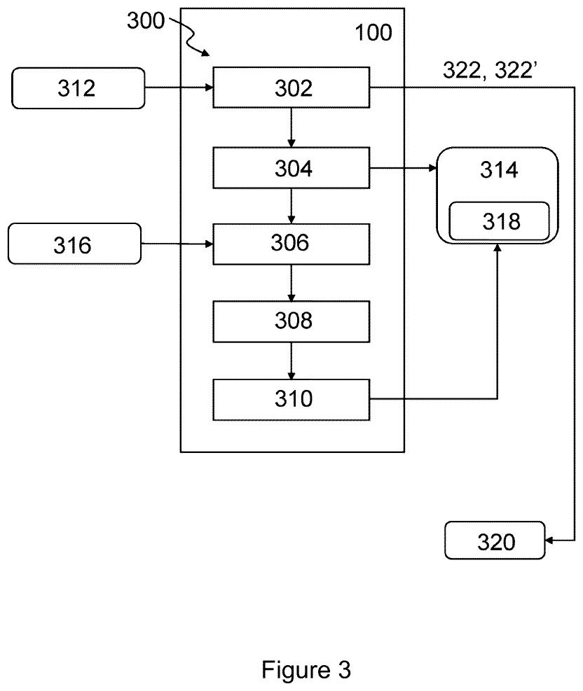

Examples of a method 300 performed by the control system 100 for controlling a DAS indicator system of a vehicle are discussed in more detail below with reference to FIG. 3.

The method 300 comprises setting a DAS indicator system of the DAS indicator system to a high indication mode at the start of a drive cycle 302. The DAS indicator system is configured to indicate operation of the DAS of the vehicle, and the high indication mode is a mode in which a plurality of operation indicators corresponding to respective operational driver assistance functions of the DAS are turned on. A DAS mode indication signal 322 may be provided to the DAS indicators 320 to cause them to be operational or not if those indicators can be controlled, according to the high indication mode in operation. This step 302 may take place at the start of the vehicle drive cycle, and thus may take place dependent on receipt of a signal indicating the start of the drive cycle (e.g. from the vehicle ignition 312 when the vehicle ignition is switched on).

The method 300 comprises outputting a mode indicator signal 304. The mode indicator signal is configured to cause a display screen 314 to display, in the field of view of the driver of the vehicle, a mode indicator 318 to indicate that the DAS indication mode is set to the high indication mode.

The method 300 comprises receiving at least one input signal 306. The at least one input signal is indicative of a user input made to an input element 316 located at the steering wheel of the vehicle. The at least one input signal 306 is indicative of a request to change the DAS indication mode from the high indication mode.

The method 300 comprises, in dependence on the at least one input signal 306, changing the DAS indication mode 308 from the high indication mode to a different indication mode by turning off one or more operation indicators in accordance with the different mode. This may be performed by outputting a further DAS mode indication signal 322′ to the DAS indicators 320 to cause them to operate in the different mode.

The method 300 comprises outputting a mode change signal 310. The mode change signal is configured to cause the display screen 314 to change the mode indicator 318 to indicate that the DAS indication mode is set to the different indication mode.

The method shown in FIG. 3 may be performed by computer readable instructions which, when executed by a computer, are arranged to perform the method. There may be a non-transitory, computer-readable storage medium (e.g. a memory 130) storing instructions thereon that, when executed by one or more electronic processors (e.g. processor 120), causes the one or more electronic processors to carry out any method disclosed herein. Thus, the methods disclosed herein may be performed by computer code operating in an existing vehicle DAS indicator system.

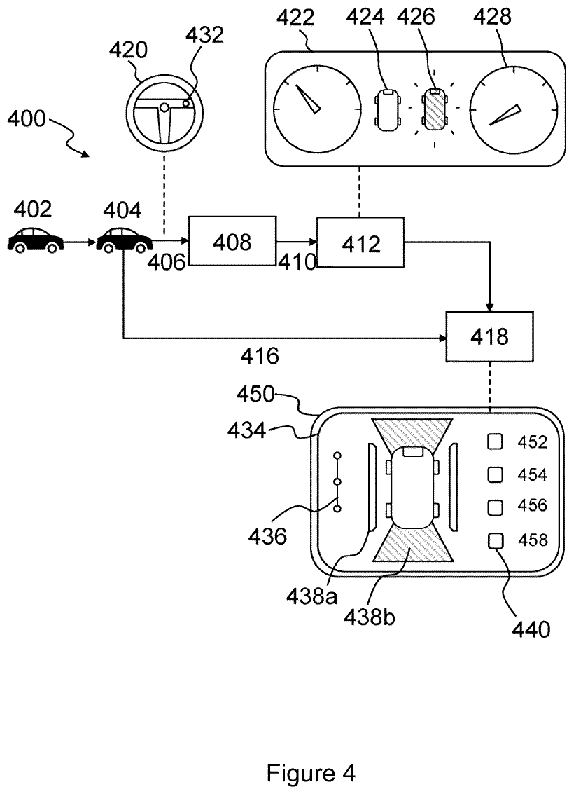

FIG. 4 shows a schematic example process 400 of controlling a DAS indicator system of a vehicle, following from the example of FIG. 3. The various processes may be performed by a control system 100 as in FIG. 2.

The vehicle initially, as shown by the vehicle symbol 402, is stationary with the ignition off. On switching the ignition on, the vehicle moves into a state shown by vehicle symbol 404 at the start of the drive cycle (which may also be called the ignition cycle). At this state 404, the level of DAS indications may be re-set to a high indication mode because a new drive-cycle has started (for example, in vehicles adhering to GSR2 regulatory requirements). In other words, the control system 100 is configured to set a DAS indication mode of the DAS indicator system to a high indication mode at the start of a drive cycle 404. In some examples, there may be a DAS indication state before the level of DAS indications are set to a high indication mode in which all available indications are provided (for example, all possible portions of a visual indicator are illuminated), which may be used as a check that the DAS indicators are operational before the vehicle is driven. Once the vehicle moves into an operational state in which driving can commence the level of DAS indications may be set to the high indication mode. In other examples, in this state 404, the level of driver assistant system indications may be re-set to a last-used indication mode (for example, a personalised custom mode set by the driver in a non-GSR2 adherent vehicle and stored for use in a next drive cycle on the drive cycle recommencing).

The high indication mode may be indicated to the driver by a DAS indication mode indicator in the line of sight of the driver looking at the road ahead, for example an illuminated icon 424 on a vehicle cluster 422. That is, the DAS indicator system is configured to indicate operation of the DAS of the vehicle as operating in the high indication mode. The high indication mode is a mode in which a plurality of operation indicators corresponding to respective operational driver assistance functions of the DAS are turned on. This high indication mode is activated by the control system 100 being configured to output a mode indicator signal which is configured to cause the display of a mode indicator 424 to indicate that the DAS indication mode is set to the high indication mode.

The driver may interact with an input means 432, which may be a button or other input element located on or at a steering wheel 420, to control the DAS indication mode in operation. In this example, the driver can enter a mode selection mode with a first interaction 406 with the input means 432. Once in the mode selection mode 408, the driver may be able to make a further one or more inputs by interacting with the input means 432 to select a particular DAS indication mode. In other words, the control system 100 is configured to receive at least one input signal 406 which is indicative of a user input made to an input element 432 located at the steering wheel 420 of the vehicle. The at least one input signal 406 is indicative of a request to change the DAS indication mode from the high indication mode. In dependence on the at least one input signal 406, the control system 100 is configured to change the DAS indication mode from the high indication mode to a different indication mode. This may be done by disabling one or more of the plurality of operation indicators in accordance with the different indication mode.

The DAS indication modes comprise a plurality of indication modes (a high indication mode and at least one further indication mode). These modes may be stored as a numbered list in a memory of the vehicle. The high indication mode may be the first entry of the list, and following each input made to the input means, the list may be cycled through to move through the plurality of available DAS indication modes. The DAS indication modes may be ordered first from the DAS indication mode providing the highest level of DAS indicators though subsequently lower levels of DAS indicators before moving back to the high DAS indication mode. Thus, the indication modes may be scrolled through by providing plural inputs to the input element 432, for example by successive jog inputs made to a jog wheel as an input means 432, or repeated pressing of a button as input means 432, allowing for a simple way for the driver to make inputs to move through available indication modes to settle on a desired indication mode. Example input means 432 include a push button, a dial, a switch, a jog wheel, and a touch pad. It may be advantageous to use an input means 432 which allows for repeated inputs to be made and recognised by the control system for a series of related inputs; for example a first input indicates a desire to select a DAS indication mode, and subsequent repeated inputs then scroll through the carousel of available DAS indication modes.

In some examples, the plurality of indication modes may include the high indication mode, a custom indication mode, and a low indication mode. In some examples there may be more than one custom indication mode. In some examples, each driver may have a personalised customisation mode stored and linked to their driver profile, so the driver may be recognised by the vehicle (for example through entry of a passcode or recognition of the driver's personal vehicle key or mobile device) and their personalised customisation mode may be the custom mode provided as an option for selection. The custom indication mode may be an indication mode in which a predetermined selection of the plurality of operation indicators are turned on. In some examples, on first use, the settings for the indication mode may be set to an optimum experience for a “typical” user (for example, as determined by customer questionnaires and/or data capture from vehicle in which a custom indication level has been set) in which some indicators are enabled and some indicators are disabled, for example. A customisation may then be permitted for the user to customise their settings to suit them personally. The customisation may have previously been made by a user interacting with the DAS indicator configuration page 434 (discussed below), for example.

The low indication mode may be an indication mode in which a subset of the plurality of operation indicators are turned on, wherein the subset of operation indicators represents operation indicators which cannot be turned off. For example, if certain DAS indications are required to be active to meet regulatory requirements, in a low indication mode, only these DAS indications may be operational and all others may be disabled. Advantageously, the user may be able to quickly switch to a pre-stored indication mode which defines a particular plurality of DAS indicators which are in operation, without for example, being required to enter a settings menu and manually activate or deactivate individual DAS indicators.

The control system 100 is then configured to output a mode change signal which is configured to cause the display screen 422 to change the mode indicator 424, 426 to indicate that the driver assistance system indication mode is set to the different indication mode. Thus, the DAS indication mode in current operation 412 is indicated to the driver by a DAS indication mode indicator 426 in the line of sight of the driver looking at the road ahead, for example on a vehicle cluster 422 (as an example of a display screen).

In some examples, the at least one input signal made by the driver to select a particular DAS indication mode may comprise a mode change input signal 406 which is indicative of a user request to enter a mode selection mode. This mode change input signal 406 may then be followed by one or more mode selection input signals 410, wherein each of the one or more mode selection input signals is indicative of a request to change the DAS indication mode to a different indication mode, such as a next indication mode in an ordered indication mode list. Advantageously, the user is able to provide input to the input means 432 to first indicate that they wish to change the DAS indication mode, followed by further input to scroll through the available indication modes. In this way, the initial input to indicate a desire to change mode helps to ensure that the indication mode is not switched accidentally by accidentally tapping or knocking the input means once, and the second (and further) inputs are those which allow for quick cycling through the available mode to select a desired mode. The type of input provided (e.g. a button press lasting less than a predetermined time e.g. 1 second; or a jog of a jog wheel in a particular direction) may be the same for both the mode change input signal 406 and the mode selection input signals 410, but it is the initial input 406 recognised as the mode change input signal 406. Thus the user is able to interact with the input means 432 in a straightforward way to enter the mode selection mode and select a desired mode simply by making repeated inputs.

The control system may be configured to determine, in response to receiving each of the one or more mode selection input signals 410, whether a predetermined period of time has passed since receiving the mode change input signal 406. After the predetermined period of time has passed, if a further input signal is received indicative of a further user input made to the input element 432, the further input signal may be determined to be a further mode change input signal 406 indicative of a request to enter the mode selection mode. In this way the control system may provide a “time-out” feature to further protects against accidental mode switching, for example by knocking or touching the input means 432 by accident. The user in this example is required to provide successive inputs 410 within a predetermined time period, otherwise the control system reverts back to requiring an initial input 406 to indicate a desire to change the current mode before the mode is able to be changed by subsequent inputs 410. In some examples, the indication mode may not be changed until the predetermined period of time has passed. This feature helps prevent a change to the control of all the DAS indicators to be in a particular selected mode until the particular indication mode is decided upon.

In some examples, the control system may be configured to output a mute signal which is configured to mute audio output when the mode change input signal is received. This may help to signal e.g. to the driver that the indication mode is being changed. Audio will be output again the next time it is required according to the currently active/selected mode. Advantageously, the user may change the DAS indication mode using the input means 432 to disable one or more of the plurality of operation indicators in accordance with the different indication mode and audio output is paused during a mode change to indicate to the driver the mode is being changed. For example, a speed related warning audio tone may be temporarily muted when the button is pressed to select a different indication mode, but the audio may not be turned off, because it can be output again the next time the audio indication is required. The driver will have to change mode to a mode in which overspeed audio indication is not provided to turn off the overspeed warning tone. In some examples, selection of a DAS indication mode may (on selection and/or confirmation of a particular selected DAS indication mode) cause an audio tone to be provided to signal DAS indication mode selection. The audio tone may, for example, be representative of audio indication provided in the selected DAS indication mode, e.g. having the same tone type, volume, duration, etc as audio indication provided in the selected DAS indication mode.

In this example, an icon 424, 426 is illuminated to indicate the currently operational DAS indication mode. In this schematic example there are two icons 424, 426 indicative of a high DAS indication mode 424 and a further DAS indication mode 426. In other examples there may more than two indicators 424, 426, In other examples there may be one single DAS indication mode indicator with different portions which may be illuminated or not illuminated to indicate the currently operational DAS indication mode. For example, in a DAS indicator mode in which indicators are provided to indicate operation of a forward collision sensing mode, a front portion of the schematically indicated vehicle-shaped icon may be illuminated; in a DAS indicator mode in which indicators are provided to indicate lane assistance, lateral/side portions of the schematically indicated vehicle-shaped icon may be illuminated. In other examples still, an icon may be displayed which indicates a number, letter, or other symbol to indicate the currently operational DAS indicator mode. In other examples still, an icon may be displayed which comprises a plurality of bars and a selected mode having a high level of DAS indication provided may be represented by a higher number of bars being illuminated, whereas a low level of DAS indication provided may be represented by a lower number of bars being illuminated Other possible icon or indicator designs may be used.

Once the DAS indication mode has been set the system can operate in the selected DAS indication mode 418.

The DAS indication mode may also be set in some examples by entering a DAS indicator configuration page 434, for example by executing a different type of interaction 416 with the input means (e.g. a press for longer than a predetermined period such as 1 second or 2 seconds), or by interacting with a different input means (for example, navigating a menu system on a touch screen 450 to enter the DAS indicator configuration page 434 displayed on the touch screen 450). That is, in some examples the control system may be configured to output a mode information page display signal, to cause a display screen 450 to display a DAS mode information page, in response to receiving a DAS indication mode information page input. The DAS indication mode information page input may be a long press to the input means, an interaction on a touch screen 450 which displays the mode information, or an interaction with a further input means such as a different button to the input means use to toggle through the DAS indication modes.

In an example, each of the at least one input signal indicative of a request to change the DAS indication mode comprises a short duration user input to the input means 432; and the DAS indication mode information page input comprises a long duration user input to the input means. Advantageously, the user need only interact with a single input means to be able to both control which DAS indicated mode is in operation by toggling through the available modes, as well as being able to access further information about each DAS indication mode by using a long duration user input to the input means 432.

The DAS indicator configuration page 434 (which may also be called a DAS mode information page 434 in that it provides information about the available DAS indication modes) comprises information indicative of the operational driver assistance functions of the DAS. For example, an indication may be provided to show what the current DAS indication mode is (e.g. high, custom, and low, shown as points on a list 436). When the DAS mode information page 434 is displayed, a user may be able to toggle through the available DAS indication modes by interacting with the input means 432 and/or interacting with the displayed list 436 on the touch screen 450, for example.

Further, for example, there may be information displayed about operational DAS functionality, in this example shown as a list 452, 454, 456, 458 on one side of the display. Such information may include an overspeed warning operational state(wherein an indication is provided when the vehicle speed is approaching, crosses, or is exceeding, a speed limit at the vehicle location); a new speed limit warning operational state (wherein an indication of an upcoming change in speed limit is provided, such as a visual indicator displaying the new speed limit and possibly the current speed limit which is about to end), a lane assistance operational state (whereby sensors on each side of the vehicle are used to determine the vehicle is driving in lane and an alert or assistive vehicle control is activated if the vehicle is determined to be unintentionally moving out of lane), and a forward alert, e.g. a forward collision and emergency braking operational state (whereby sensors on the front of the vehicle are used to determine whether the vehicle is a predetermined distance from a vehicle in front and provides an alert if the separation distance from the vehicle in front is too small or the vehicle appears to be driving too fast with respect to the vehicle or other entity in front, and if emergency braking would be activated to mitigate against the possibility of a collision event).

The DAS mode information page 434 comprises information indicative of which DAS indicators are provided in each of the DAS indication modes. For example, a tick, green light, or other indicator 440 may be displayed next to each DAS functionality listed 452, 454, 456, 458 to show whether an indicator related to that functionality is active or not, and/or what type of indication (e.g. visual, audio, haptic) is active. Other indications of the active DAS functionality may be provided, such as a schematic display of an active sensor to indicate sensing in that region of the vehicle—the example shows that lateral/side sensing 438a is not illuminated and so indicators to alert the driver to lane assistance, which uses lateral/side sensing 438a, are not being provided, whereas front and rear sensing 438b is illuminated and so indicators to alert the driver to forward collision sensing and to rear parking proximity to obstacles, which uses front sensing and rear sensing respectively, is being provided. Of course other combination of indicators and DAS functionality may be provided. Therefore, advantageously, an input may be made to access a DAS mode information page 434 to provide information on which DAS indicators are operational, and which are not, in the current (or an available) indication mode.

The information regarding the available indication modes 438a, 438b, 440 provided in the DAS mode information page 434 may comprise information of each operation indicator 452, 454, 456, 458 and whether each operator indicator is turned on or off or is not available for a selected DAS indication mode. In some examples, without entering the DAS mode information page 434, the operational DAS indication modes may be indicated as operational or not in the way the DAS indication mode indicator 424, 426 is displayed. For example, the DAS indication mode indicator 424, 426 may comprise portions associated with particular DAS indicators, and if the portion is illuminated that DAS indicator is operational, whereas if the portion is not illuminated, that DAS indicator is not operational. In some examples, different colour illumination may be used to indicate which DAS indicators are operational, and in what way (for example, no indication provided for a DAS function may be indicated by no illumination of a corresponding portion of the DAS indication mode indicator; active audio alerts may be indicated by blue illumination; visual audio alerts may be indicated by green illumination, haptic alerts may be indicated by yellow illumination, and two or more types of alert may be indicated by white illumination). Of course other combinations of shape, colour, illumination brightness, etc. may be used to indicate on the display means 450 (and/or on the display screen 422 in the line of sight of the driver) which of various types of DAS indications are active or not active. Advantageously, it is clear which indicators are operational in a particular indication mode from the display of a DAS indication mode indicator in the field of view of the driver looking at the road ahead. Examples disclosed herein thus provide a system 400 for a vehicle 10, wherein the system 400 comprises any control system 100 disclosed herein, an input element 432; and a display screen 422 on which the DAS indication mode indicator(s) is/are to be displayed. In some examples the system may further comprise a further display screen 450 (e.g. a touch screen 450) which is configured to display the DAS indicator configuration page 434. It will be appreciated that various changes and modifications can be made to the present invention without departing from the scope of the present application.

1. A control system for controlling a driver assistance system indicator system of a vehicle, the control system comprising one or more controller, the control system configured to:
set a driver assistance system indication mode of the driver assistance system indicator system to a high indication mode at a start of a drive cycle, wherein the driver assistance system indicator system is configured to indicate operation of the driver assistance system of the vehicle, and wherein the high indication mode is a mode in which a plurality of operation indicators corresponding to respective operational driver assistance functions of the driver assistance system are turned on;
output a mode indicator signal, the mode indicator signal configured to cause a display screen to display, in a field of view of a driver of the vehicle looking at a road ahead, a mode indicator to indicate that the driver assistance system indication mode is set to the high indication mode;
receive at least one input signal, the at least one input signal indicative of a user input made to an input element located at a steering wheel of the vehicle, the at least one input signal indicative of a request to change the driver assistance system indication mode from the high indication mode;
in dependence on the at least one input signal, change the driver assistance system indication mode from the high indication mode to a different indication mode by disabling one or more of the plurality of operation indicators in accordance with the different indication mode; and
output a mode change signal, the mode change signal configured to cause the display screen to change the mode indicator to indicate that the driver assistance system indication mode is set to the different indication mode.

2. The control system of claim 1, wherein the driver assistance system indication mode comprises a plurality of indication modes stored as a numbered list in a memory of the vehicle, wherein the high indication mode is a first entry of the list.

3. The control system of claim 2, wherein the plurality of indication modes includes the high indication mode, a custom indication mode, and a low indication mode;
wherein the custom indication mode is an indication mode in which a predetermined selection of the plurality of operation indicators are turned on; and
wherein the low indication mode is an indication mode in which a subset of the plurality of operation indicators are turned on, wherein the subset of operation indicators represents operation indicators which cannot be turned off.

4. The control system of claim 1, wherein the at least one input signal comprises:
a mode change input signal indicative of a user request to enter a mode selection mode; followed by
one or more mode selection input signals, wherein each of the one or more mode selection input signals is indicative of a request to change the driver assistance system indication mode to a next indication mode in a numbered list.

5. The control system of claim 4, wherein the control system is configured to:
determine, in response to receiving each of the one or more mode selection input signals, whether a predetermined period of time has passed since receiving the mode change input signal;
wherein, after the predetermined period of time has passed, if a further input signal is received indicative of a further user input made to the input element located at the steering wheel of the vehicle, the further input signal is determined to be a further mode change input signal indicative of a request to enter the mode selection mode.

6. The control system of claim 5, wherein the indication mode is not changed until the predetermined period of time has passed.

7. The control system of claim 1, wherein the control system is configured to:
in response to receiving a driver assistance system indication mode information page input, output a mode information page display signal to cause the display screen to display a driver assistance system mode information page;
wherein the driver assistance system mode information page comprises information indicative of:
the operational driver assistance functions of the driver assistance system; and
which driver assistance system indicators are provided in each of the driver assistance system indication modes.

8. The control system of claim 7, wherein:
each of the at least one input signal indicative of a request to change the driver assistance system indication mode comprises a short duration user input to the input means; and
the driver assistance system indication mode information page input comprises a long duration user input to the input means.

9. The control system of claim 1, wherein the control system is configured to:
output a mute signal, the mute signal configured to mute output when a mode change input signal is received.

10. The control system of claim 1, wherein the plurality of operation indicators comprises one or more of: a visual indicator, an audio indicator, and a haptic feedback indicator.

11. The control system of claim 1, wherein the input element comprises one or more of: a push button, a dial, a switch, a jog wheel, and a touch pad.

12. A system for a vehicle, the system comprising
the control system of claim 1; and
the input element; and
the display screen.

13. A vehicle comprising the control system of any claim 1.

14. A method for controlling a driver assistance system indicator system of a vehicle, the method comprising:
setting a driver assistance system indication of the driver assistance system indicator system to a high indication mode at a start of a drive cycle, wherein the driver assistance system indicator system is configured to indicate operation of the driver assistance system of the vehicle, and wherein the high indication mode is a mode in which a plurality of operation indicators corresponding to respective operational driver assistance functions of the driver assistance system are turned on;
outputting a mode indicator signal, the mode indicator signal configured to cause a display screen to display, in a field of view of the driver of the vehicle, a mode indicator to indicate that a driver assistance system indication mode is set to the high indication mode;
receiving at least one input signal, the at least one input signal indicative of a user input made to an input element located at a steering wheel of the vehicle, the at least one input signal indicative of a request to change the driver assistance system indication mode from the high indication mode;
in dependence on the at least one input, changing the driver assistance system indication mode from the high indication mode to a different indication mode by turning off one or more operation indicators in accordance with the different mode; and
outputting a mode change signal, the mode change signal configured to cause the display screen to change the mode indicator to indicate that the driver assistance system indication mode is set to the different indication mode.

15. Computer readable instructions which, when executed by a computer, are arranged to perform a method according to claim 14.
